(19) United States
(12) Patent Application Publication
(10) Pub. No.: US 2026/0309608 A1
(43) Pub. Date: Oct. 8, 2026

(54) METHOD FOR DETERMINING A MEASUREMENT VARIABLE OF A MEDIUM

(71) Applicant: Endress+Hauser SE+Co. KG, Maulburg (DE)

(72) Inventors: Nic Kaufmann, Schopfheim (DE); Mohammad Sadegh Ebrahimi, Lörrach (DE); Tobias Brengartner, Emmendingen (DE); Berthold Fuchs, Steinen (DE); Harald Bauer, Lörrach (DE); Laura Mignanelli, Maulburg (DE)

(21) Appl. No.: 19/483,721

(22) PCT Filed: Mar. 26, 2024
(86) PCT No.: PCT/EP2024/058113

§ 371 Date: Nov. 12, 2025

(30) Foreign Application Priority Data
May 23, 2023 (DE) 10 2023 113 474.4

(51) Int. Cl. G01N 11/16

(52) U.S. Cl. CPC G01N 11/16

(57) ABSTRACT

A method for ascertaining a measured variable of a medium includes a mechanically oscillatable unit that is so brought in contact with the medium that the medium covers at least a part of the mechanically oscillatable unit. Then, the mechanically oscillatable unit is so positioned that a drop formation of the medium is enabled, and excited, such that mechanical oscillations are executed. For at least one characteristic variable of the mechanical oscillations, measured values are ascertained at different points in time. A time behavior resulting therefrom is evaluated concerning the measured variable.

The invention relates to a method for ascertaining a measured variable of a medium.

In the state of the art, vibration sensors are known, which are embodied e.g. as oscillatory forks or single rods. Such sensors have a mechanically oscillatable unit, which is excited by an exciting/receiving unit, such that mechanical oscillations are executed. The oscillations resulting from the interaction with a medium to be measured or monitored are received by the exciting/receiving unit and fed to an evaluation.

Utilized for measurement is, for example, that the oscillation frequency or the amplitude changes, when the mechanically oscillatable unit transitions from an uncovered state to a state covered by the medium. This enables e.g. the monitoring of the fill level of a medium in a container.

In DE 10 2021 126 826A1 , different media should be detected with an oscillatory fork based on a calibration measurement. In an embodiment, the calibration is performed, while medium clings to the sensor.

DE 10 2020 121 610 A1 relates to an oscillatory fork, where it is observed via an optical distance sensor, whether medium is clinging to the fork.

DE 10 2014 115 693 A1 describes an oscillatory fork, whose paddles are optimized as regards their shedding of drops.

For intrinsic variables of a medium, e.g. its viscosity, very complex measuring devices are most often required.

An object of the invention is to provide a method, with which also intrinsic measured variables of a medium can be ascertained as simply as possible.

The object is achieved by a method for ascertaining a measured variable of a medium, wherein the method comprises method steps as follows:
a) bringing a mechanically oscillatable unit so in contact with the medium that the medium covers at least a part of the mechanically oscillatable unit,
b) so positioning the mechanically oscillatable unit that a drop formation of the medium on the mechanically oscillatable unit is enabled,
c) exciting the mechanically oscillatable unit at least during step b), such that mechanical oscillations are executed,
d) ascertaining measured values for at least one characteristic variable of the mechanical oscillations at different points in time, and
e) evaluating a time behavior of the measured values resulting from the ascertained measured values regarding the measured variable.

In the method of the invention, the mechanically oscillatable unit is brought so in contact with the medium, whose measured variable should be ascertained, that the medium at least partially covers the mechanically oscillatable unit. Then, the mechanically oscillatable unit is so positioned that a drop formation of the medium on the mechanically oscillatable unit is possible. The medium is, thus, especially a flowable medium, such as e.g. a liquid. In this state, in which medium is located on the mechanically oscillatable unit, the mechanically oscillatable unit is excited to execute oscillations. These oscillations depend, in such case, on the medium located on the mechanically oscillatable unit. Therefore, also the characteristic variables ascertainable from the received mechanical oscillations depend on the interaction with the medium.

Characteristic variables are e.g. frequency, amplitude, phase or quality. At least one characteristic variable is ascertained at different points in time, in order to register the time behavior of the medium on the mechanically oscillatable unit. Especially, the drop formation, or the shedding of drops, of the medium is registered, in order to ascertain therefrom the measured variable of interest for the medium. Whether drops form or not depends, in such case, also on the properties of the medium.

In an embodiment, another variable of the medium is ascertained. This other variable of the medium is preferably its temperature. E.g. present for this is a temperature sensor. Supplementally or alternatively, at least one other characteristic variable of the oscillations is ascertained and used for the evaluation.

An embodiment of the method provides that in step a) the mechanically oscillatable unit is immersed at least partially in a quantity of the medium in a container, and then—preferably completely—pulled out. The mechanically oscillatable unit is, thus, by an immersion, coated, at least partially, with the medium. In order that then drops can form, the mechanically oscillatable unit is pulled back out of the medium. In a supplementing embodiment, the mechanically oscillatable unit is pulled completely out of the medium in the container by a relative movement between the mechanically oscillatable unit and the container. Thus in an embodiment, the mechanically oscillatable unit is withdrawn from the container. Alternatively, the container is moved away from the locationally fixed, mechanically oscillatable unit. In an additional embodiment, both aforementioned variants can also be combined.

An alternative embodiment includes that the medium is brought to the mechanically oscillatable unit by a media line or a spray unit.

The drop formation is supported in an embodiment by the feature that in step b) the mechanically oscillatable unit is oriented at a predeterminable angle of inclination to the gravitational field. The mechanically oscillatable unit is, thus, in this embodiment preferably arranged inclined, such that the medium can, for example, flow to the end of the unit and there form drops.

The following embodiments relate especially to evaluation of the characteristic variables ascertained from the oscillations.

Thus, an embodiment provides that in step e) instabilities in the time behavior are identified. If a drop forms and it is shed from the mechanically oscillatable unit, then there results therewith an abrupt change of the influencing of the mechanical oscillations, this in turn resulting in an instability of the characteristic variable of the oscillations. If one starts from the idea that the drop formation is a function of the measured variable of interest, then the instabilities serve in this embodiment for ascertaining the measured variable.

Another embodiment provides that in step e) the case, that, within a predeterminable period of time, a change of the measured value exceeds a predeterminable limit value is evaluated as drop shedding moment of the medium, that from the at least one drop shedding moment of the medium information concerning a drop shedding behavior of the medium is ascertained, and that the information concerning the drop shedding behavior is compared with furnished data, in order to ascertain the measured variable. In this embodiment, it is detected, whether the measured value of the characteristic variable of the oscillations changes more than a certain measure in a certain time window. This relates in a variant especially to whether there is an abrupt change. If it is a situation of significant change of the measured values, then this is evaluated as a drop shedding moment, i.e. a drip of the medium from the mechanically oscillatable unit happened in this time window. From the at least one drop shedding moment or preferably a plurality of drop shedding moments, the drop shedding behavior of the medium per se is deduced. Starting from the so ascertained shedding behavior and using suitably furnished data, the measured variable of the medium is ascertained. In an alternative or supplementing variant, the curve of the measured values in the time window around the detected drop shedding moments is evaluated. This concerns, for example, the time period before a drop shedding moment. Alternatively or supplementally, an embodiment concerns a length of time between multiple drop shedding moments. Preferably, based on the measured values and the identified drop shedding moments, a plurality of variables are derived and taken into consideration for the evaluation.

The method is preferably applied for ascertaining a rheological measured variable of the medium. This measured variable is, in such case, again preferably the viscosity of the medium.

The invention will now be explained in greater detail based on the appended drawing, the figures of which show as follows:

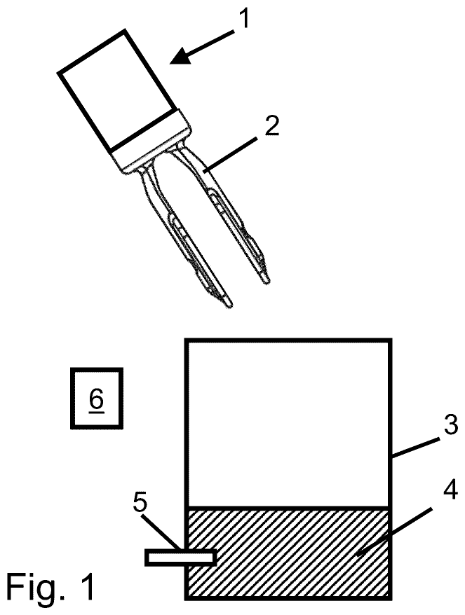

FIG. 1 a schematic and not to scale measuring arrangement for application of the method of the invention; and

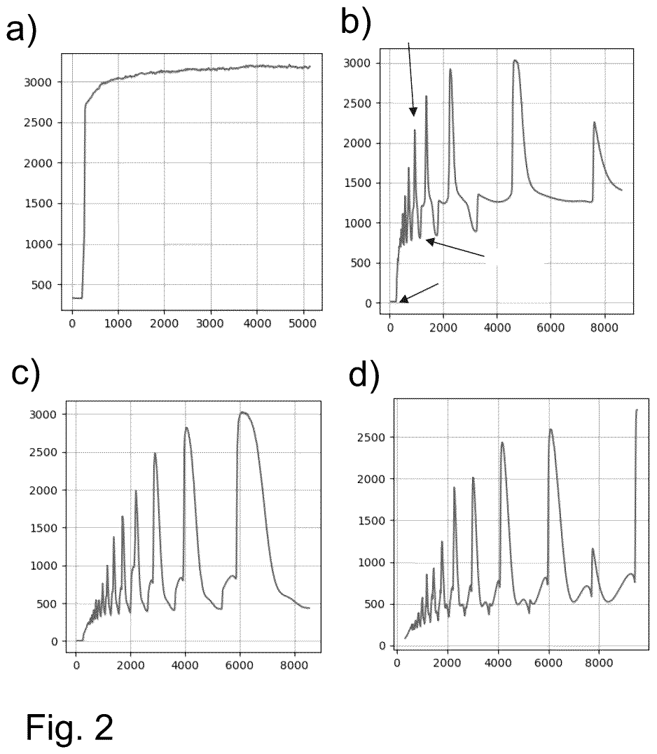

FIG. 2 the time development of the quality of the mechanically oscillatable unit in the case of wetting with water (a) and with silicone oils of three different viscosities (b) to (d).

FIG. 1 shows an oscillatory fork representing an apparatus 1 for ascertaining a measured variable of the medium 4. The two fork tines of the mechanically oscillatable unit 2 are excited to execute mechanical oscillations.

Indicated here is that the apparatus 1 is so arranged relative to the gravitational field during performance of the method that the mechanically oscillatable unit 2 is inclined at a predeterminable angle of inclination. This happens, for example, after the mechanically oscillatable unit 2 is immersed in the medium 4 within the container 3 and then pulled back out. The inclined position promotes especially the shedding of the medium 4, which at least partially covered the mechanically oscillatable unit 2.

Additionally, a temperature sensor 5 is present, which enables registering of the temperature of the medium. The measurement signals of the apparatus 1 or data relative to the oscillations as well as the results of measurement of the temperature sensor 5 are fed to an evaluation unit 6, which ascertains the measured variable of the medium 4.

FIG. 2 shows the time behavior of a characteristic variable of the mechanical oscillations as a function of the covering medium of four different viscosities.

Thus each of FIG. 2 a) to d) plots the quality of the mechanically oscillatable unit (y axis) as a function of the time (x axis, t/s). For this, quality is ascertained, in each case, at different points in time.

FIG. 2 a) shows the drop shedding behavior of the fork after immersion in water. FIG. 2 b) to d) show drop shedding behavior after immersion in silicone oils having a viscosity of about 1,000 mm²/s (FIG. 2 b)), 10,000 mm²/s (FIG. 2 c)) and 20,000 mm²/s (FIG. 2 d)). The mechanically oscillatable unit in the form of an oscillatory fork applied for the measurings has in air a quality of about 3,300 at a resonant frequency of about 1,130 Hz.

If the fork is immersed in the silicone oils (FIG. 2 b) to d)) or in water (FIG. 2 a)), then the quality sinks to a value, which is determined by the density of the media. From quality in combination with frequency of the mechanical oscillations and the temperature of the medium, here, for example, the density of the medium is deduced. If the fork is brought out of the medium, then the frequency as well as quality increase. Both values do not, however, immediately return to the starting state, since upon leaving the water a thin water film forms and upon leaving the silicone oils an oil film forms on the fork.

In the case of water (FIG. 2 a)), no drops are shed and the water film evaporates after some time.

In the case of the silicone oils (FIG. 2 b) to d)), individual drops are shed. If there is a low point in the quality and directly, thereafter, a high point, this means that a drop has been shed. Such is, thus, a drop shedding moment, in the case of which the measured values of the characteristic variable change in a certain time period more than a certain limit value.

After the shedding of the drop, the quality sinks again, because the medium flows from a site located above along the gravitational field on the mechanically oscillatable unit in the direction of its terminal end.

These special points in time are marked with arrows in the plot of FIG. 2 b). Such are (from left to right): starting value after removal from a reservoir with the medium, a local maximum of the quality after the shedding of a drop and the abrupt rise of the quality after the shedding of a drop in a local minimum of the quality.

Clear is that a drop shedding behavior characteristic for the medium is displayed for the quality as a function of time. Based on the duration of the drop shedding and the course of the drop shedding curve, thus the drop shedding characteristic, suitable algorithms allow the ascertaining of the viscosity and the density as measured variables of the medium.

### List OF REFERENCE CHARACTERS

1 apparatus
2 mechanically oscillatable unit
3 container
4 medium
5 temperature sensor
6 evaluation unit

1-6. (canceled)

7. A method for ascertaining a measured variable of a medium, the method comprising:
a) bringing a mechanically oscillatable unit so in contact with the medium that the medium covers at least a part of the mechanically oscillatable unit;
b) positioning the mechanically oscillatable unit so that a drop formation of the medium on the mechanically oscillatable unit is enabled;
c) exciting the mechanically oscillatable unit at least during step b), such that mechanical oscillations are executed;
d) ascertaining measured values for at least one characteristic variable of the mechanical oscillations at different points in time; and
e) evaluating a time behavior of the measured values resulting from the ascertained measured values regarding the measured variable.

8. The method as claimed in claim 7,
wherein in step a) the mechanically oscillatable unit is immersed at least partially in a quantity of the medium in a container, and then pulled out.

9. The method as claimed in claim 8,
wherein in step b) the mechanically oscillatable unit is oriented at a predeterminable angle of inclination to a gravitational field.

10. The method as claimed in one of claim 7,
wherein in step e) instabilities in the time behavior are identified.

11. The method as claimed in one of claim 7,
wherein in step e) the case, that, within a predeterminable period of time, a change of the measured value exceeds a predeterminable limit value is evaluated as drop shedding moment of the medium,
wherein from the at least one drop shedding moment of the medium information concerning a drop shedding behavior of the medium is ascertained, and
wherein the information concerning the drop shedding behavior is compared with furnished data to ascertain the rheological measured variable.

12. The method as claimed in one of claim 7,
wherein a viscosity of the medium is ascertained as a rheological measured variable.
